(19) United States
(12) Patent Application Publication
(10) Pub. No.: US 2020/0230015 A1
(43) Pub. Date: Jul. 23, 2020

(54) WALKING ASSIST DEVICE

(71) Applicant: JTEKT CORPORATION, Osaka-shi (JP)

(72) Inventors: Yoshiyuki SHIBATA, Toyota-shi (JP); Manabu KANAYA, Nara-shi (JP); Yuki MATSUOKA, Kariya-shi (JP); Genki MURATA, Shiki-gun (JP)

(73) Assignee: JTEKT CORPORATION, Osaka-shi (JP)

(21) Appl. No.: 16/743,434

(22) Filed: Jan. 15, 2020

(30) Foreign Application Priority Data
Jan. 22, 2019 (JP) 2019-008662

(51) Int. Cl. A61H 3/04

(52) U.S. Cl. CPC A61H 3/04; A61H 2003/043; A61H 2003/046; A61H 2201/1215; A61H 2201/5084; A61H 2201/1635; A61H 2201/5064; A61H 2201/5079

(57) ABSTRACT

A walking assist device includes a frame; wheels including at least one driving wheel; at least one traveling drive unit; a battery; right and left handles; handle condition detection units; an electronic control unit configured to control the at least one traveling drive unit based on the conditions of the handles that are detected based on detection signals from the respective handle condition detection units; right and left shafts fixed to the respective handles and extending in a frame front-rear direction; and right and left tubes that are attached to the frame so as to extend in the frame front-rear direction, the tubes being configured to house the respective shafts such that the shafts are movable in the frame front-rear direction.

### INCORPORATION BY REFERENCE

The disclosure of Japanese Patent Application No. 2019-008662 filed on Jan. 22, 2019 including the specification, drawings and abstract is incorporated herein by reference in its entirety.

### BACKGROUND

### 1. Technical Field

The disclosure relates to a walking assist device.

### 2. Description of Related Art

In order that a user who can walk autonomously can train himself/herself to walk naturally with higher quality, it is very important to walk with his/her arms properly swinging in synchronization with legs in a proper posture in which the body trunk is kept straight without leaning on a walking frame.

For example, in a hand cart described in Japanese Unexamined Patent Application Publication No. 2017-12546 (JP 2017-12546 A), when a user grips and pushes a handle bar fixed to the hand cart so as to extend in a lateral direction, an assist force for assisting movement in a traveling direction is generated in the hand cart depending on the magnitude and the direction of a handle force for pushing the hand cart.

For example, an electric four-wheel hand cart described in Japanese Unexamined Patent Application Publication No. 8-280763 (JP 8-280763 A) moves forward by electric power when a movable hand cylinder fixed to the electric four-wheel hand cart so as to extend in a lateral direction is gripped and pushed forward and obliquely downward. The electric four-wheel hand cart is automatically stopped when the movable hand cylinder is released.

### SUMMARY

In the hand cart described in JP 2017-12546 A, the handle bar to be gripped by the user is fixed to the hand cart. Therefore, the hand cart cannot assist high-quality walk training in which the user walks with his/her arms properly swinging in synchronization with movement of legs.

In the electric four-wheel hand cart described in JP 8-280763 A, the movable hand cylinder to be gripped by the user is fixed to the electric four-wheel hand cart similarly to JP 2017-12546 A. Therefore, the electric four-wheel hand cart cannot assist high-quality walk training in which the user walks with his/her arms properly swinging in synchronization with movement of legs.

The disclosure provides a walking assist device that can assist high-quality walk training in which a user walks with his/her arms properly swinging in synchronization with movement of legs.

An aspect of the disclosure relates to a walking assist device including: a frame; a plurality of wheels provided on the frame and including at least one driving wheel; at least one traveling drive unit configured to drive the at least one driving wheel; a battery configured to operate the at least one traveling drive unit; a pair of right and left handles configured to be gripped by a user to move in a frame front-rear direction that is a front-rear direction of the frame; handle condition detection units configured to detect conditions of the respective handles; an electronic control unit configured to control the at least one traveling drive unit based on the conditions of the handles that are detected based on detection signals from the respective handle condition detection units; a pair of right and left shafts fixed to the respective handles and extending in the frame front-rear direction; and a pair of right and left tubes that are attached to the frame so as to extend in the frame front-rear direction, the tubes being configured to house the respective shafts such that the shafts are movable in the frame front-rear direction.

With the structure described above, the pair of right and left shafts are fixed to the pair of right and left handles configured to be gripped by the user, respectively, and the pair of right and left shafts are housed in the pair of right and left tubes, respectively, and movable in the frame front-rear direction. When the user walks with his/her arms swinging back and forth together with the gripped handles, the electronic control unit causes the walking assist device to travel by controlling the at least one traveling drive unit based on an arm swinging condition (conditions of the handles). Thus, the walking assist device can assist high-quality walk training in which the user walks with his/her arms properly swinging in synchronization with movement of legs.

In the above aspect, the tubes and the shafts may include retaining structures that prevent detachment of the shafts from the tubes.

With the structure described above, detachment of the shafts from the tubes is prevented. Therefore, a higher safety level is secured, and the user can concentrate on arm swinging walk without worrying about detachment of the shafts from the tubes.

In the above aspect, the tubes and the shafts may include rotation prevention structures that prevent rotation of the shafts in the tubes about shaft central axes extending in the frame front-rear direction.

With the structure described above, rotation of the shafts in the tubes is prevented. Therefore, the user can concentrate on arm swinging walk without applying an excess force to the handles (force for turning (wringing) the handles).

In the above aspect, a reference shaft position may be set for each of the shafts, the reference shaft position being a reference position in the frame front-rear direction relative to the tube that houses the shaft; and each of the tubes may be provided with a shaft position recovery portion configured to return, to the reference shaft position, the shaft and the handle moved forward or rearward from the reference shaft position.

With the structure described above, when the user is walking with his/her arms swinging back and forth while gripping the handles, a force for automatically returning each shaft (that is, each handle) to the reference shaft position is applied to the shaft by the shaft position recovery portion. That is, a force for returning rearward an arm swinging forward or a force for returning forward an arm swinging rearward are applied. Therefore, the walking assist device can assist the user in swinging his/her arms in the front-rear direction. When the user releases the handles, the shafts (that is, the handles) are automatically returned to the reference shaft position. Thus, the walking assist device is useful.

In the above aspect, each of the tubes may be provided with a locking mechanism switchable between a locked state in which the shaft is held within a fore-and-aft limit range in the frame front-rear direction such that the shaft is located in vicinity of the reference shaft position and an unlocked state in which the shaft is permitted to move in the frame front-rear direction beyond the fore-and-aft limit range in the frame front-rear direction.

With the structure described above, if the user does not want to walk with his/her arms swinging, the locking mechanism is switched to the locked state. Therefore, the movable range of each shaft (that is, each handle) in the frame front-rear direction can be kept within the fore-and-aft limit range in the vicinity of the reference shaft position. Thus, the walking assist device is useful.

The walking assist device according to the above aspect may further include a traveling velocity detection unit configured to detect a traveling velocity of the walking assist device relative to a ground. The handle condition detection units may be configured to output, to the electronic control unit, detection signals depending on positions of the shafts and the handles in the frame front-rear direction relative to the tubes, respectively. The electronic control unit may be configured to calculate fore-and-aft handle positions that are positions of the handles in the frame front-rear direction relative to the frame, based on the detection signals from the respective handle condition detection units, calculate handle moving velocities that are moving velocities of the handles relative to the walking assist device, based on the calculated fore-and-aft handle positions, and control the at least one traveling drive unit so as to achieve a target velocity based on the traveling velocity and at least one of i) the fore-and-aft handle positions and ii) the handle moving velocities.

With the structure described above, at least one of i) the fore-and-aft handle positions and ii) the handle moving velocities is used as the condition of the handles for determining the target velocity. Thus, the target velocity can be appropriately determined based on the traveling velocity and the condition of the handles (arm swinging condition).

The walking assist device according the above aspect may further include a traveling velocity detection unit configured to detect a traveling velocity of the walking assist device relative to a ground. In the locked state, the shafts may be movable in the frame front-rear direction within the fore-and-aft limit range. The handle condition detection units may be configured to output, to the electronic control unit, detection signals depending on positions of the shafts and the handles in the frame front-rear direction relative to the tubes, respectively. The electronic control unit may be configured to calculate fore-and-aft handle positions that are positions of the handles in the frame front-rear direction relative to the frame, based on the detection signals from the respective handle condition detection units, and control the at least one traveling drive unit such that the walking assist device is accelerated in a direction of the traveling velocity when the fore-and-aft handle positions are in front of positions corresponding to the reference shaft position in the locked state.

With the structure described above, the walking assist device is accelerated in the direction of the traveling velocity when the handles are pushed forward in the locked state in which the shafts are held in the vicinity of the reference shaft position and the user cannot walk with his/her arms swinging. Thus, the walking assist device can appropriately travel even if the user does not want to walk with his/her arms swinging.

In the above aspect, the electronic control unit may be configured to calculate handle moving velocities that are moving velocities of the handles relative to the walking assist device, based on the calculated fore-and-aft handle positions, and control, in the unlocked state, the at least one traveling drive unit so as to achieve a target velocity based on the traveling velocity and at least one of i) the fore-and-aft handle positions and ii) the handle moving velocities.

With the structure described above, in the unlocked state in which the shafts (that is, the handles) are movable in the frame front-rear direction, at least one of i) the fore-and-aft handle positions and ii) the handle moving velocities is used as the condition of the handles for determining the target velocity. Thus, the target velocity can be appropriately determined based on the traveling velocity and the condition of the handles (arm swinging condition).

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view for describing an appearance of a walking assist device;

FIG. 2 is an explanatory drawing of a frame in an unfolded state before the frame is folded in a lateral direction;

FIG. 3 is an explanatory drawing of the frame in a state in which the frame is folded in the lateral direction;

FIG. 4 is a perspective view for describing an example of appearances and structures of a tube, a shaft, and a handle;

FIG. 5 is a diagram of the tube that is viewed in a direction V in FIG. 4;

FIG. 6 is an explanatory drawing of an example of a structure of a locking mechanism when the shaft is unlocked;

FIG. 7 is an explanatory drawing of the example of the structure of the locking mechanism when the shaft is locked;

FIG. 8 is an explanatory drawing of a state in which the shaft is returned to (held at) a reference shaft position when the shaft is locked;

FIG. 9 is an explanatory drawing of a state in which a user pushes the shaft and the handle forward with respect to the reference shaft position within a fore-and-aft limit range when the shaft is locked;

FIG. 10 is an explanatory drawing of a state in which the user pulls the shaft and the handle rearward with respect to the reference shaft position within the fore-and-aft limit range when the shaft is locked;

FIG. 11 is an explanatory drawing of a state in which the user pulls the shaft and the handle far rearward with respect to the reference shaft position beyond the fore-and-aft limit range when the shaft is unlocked;

FIG. 12 is an explanatory drawing of an example of an appearance of an operation panel;

FIG. 13 is a block diagram for describing input and output of a control device of the walking assist device;

FIG. 14 is a flowchart for describing a processing procedure (general processing) of the control device of the walking assist device;

FIG. 15 is a flowchart for describing a processing procedure of input processing in the general processing illustrated in FIG. 14;

FIG. 16 is a flowchart for describing a processing procedure of processing of calculating a right (left) moving velocity, a moving direction, and an amplitude in the input processing illustrated in FIG. 15;

FIG. 17 is a flowchart for describing a processing procedure of ground velocity correction amount calculation processing in the general processing illustrated in FIG. 14;

FIG. 18 is a flowchart for describing a processing procedure of central position velocity correction amount calculation processing in the general processing illustrated in FIG. 14;

FIG. 19 is a flowchart for describing a processing procedure of traveling velocity adjustment processing in the general processing illustrated in FIG. 14;

FIG. 20 is a plan view of the walking assist device for describing a fore-and-aft handle position, a fore-and-aft central handle position, a virtual fore-and-aft reference position, and the like;

FIG. 21 is an explanatory drawing of an example of a fore-and-aft deviation-central position velocity correction amount characteristic; and

FIG. 22 is an explanatory drawing of an example of a user walking with his/her arms swinging back and forth while gripping the handles, and the positions of the walking assist device and the handles.

### DETAILED DESCRIPTION OF EMBODIMENTS

An embodiment of the disclosure is described below with reference to the drawings. An X-axis, a Y-axis, and a Z-axis in the drawings are orthogonal to each other. An X-axis direction is a forward direction when viewed from a walking assist device 10. A Y-axis direction is a leftward direction when viewed from the walking assist device 10. A Z-axis direction is a vertically upward direction when viewed from the walking assist device 10. Hereinafter, the X-axis direction is referred to as “forward direction”, a direction opposite to the X-axis direction is referred to as “rearward direction”, the Y-axis direction is referred to as “leftward direction”, a direction opposite to the Y-axis direction is referred to as “rightward direction”, the Z-axis direction is referred to as “upward direction”, and a direction opposite to the Z-axis direction is referred to as “downward direction” with respect to the walking assist device 10. A front-rear direction (in other words, a fore-and-aft direction) of a frame is hereinafter referred to as “frame front-rear direction”.

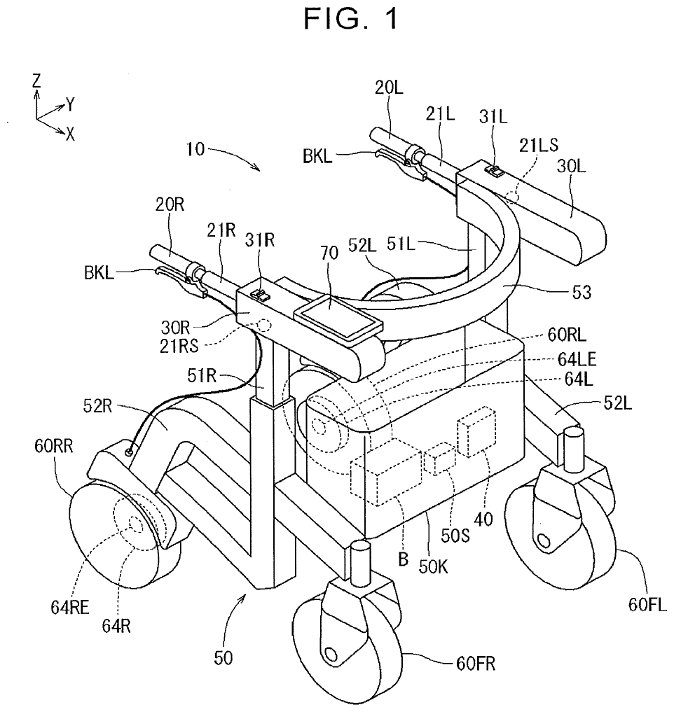

The overall structure of the walking assist device 10 is described with reference to FIG. 1. The walking assist device 10 includes a frame 50, front wheels 60FR and 60FL, rear wheels 60RR and 60RL, traveling drive units 64R and 64L, a battery B, a control device 40, handles 20R and 20L, shafts 21R and 21L, tubes 30R and 30L, and a bag 50K.

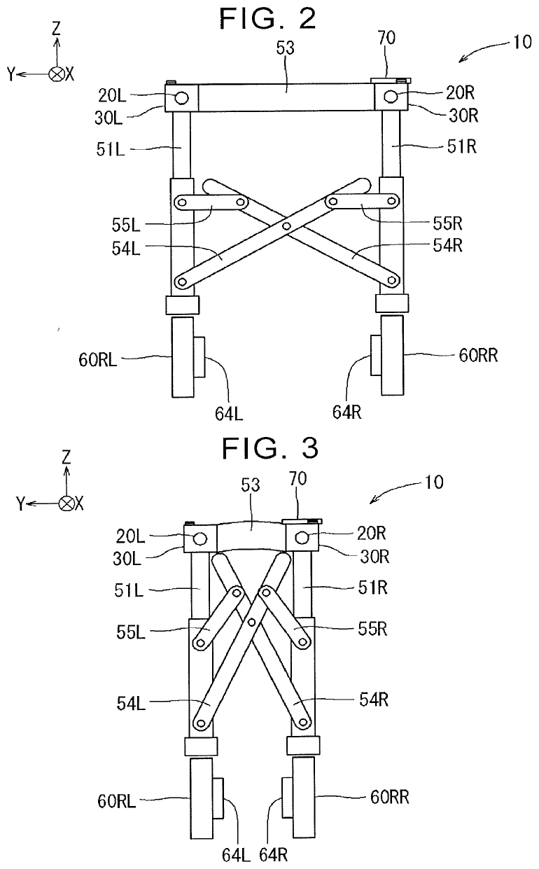

The frame 50 includes tube supports 51R and 51L and wheel supports 52R and 52L. The tube supports 51R and 51L extend in an up-and-down direction, and support the tubes 30R and 30L, respectively. The wheel supports 52R and 52L extend in the frame front-rear direction, which is the front-rear direction of the frame 50, and support the wheels, respectively. The wheel support 52R is fixed to a lower part of the tube support 51R. The wheel support 52L is fixed to a lower part of the tube support 51L. FIG. 2 illustrates a state in which the frame 50 is unfolded in a lateral direction (i.e., in a right-left direction). FIG. 3 illustrates a state in which the frame 50 is folded in the lateral direction. In FIG. 2 and FIG. 3, the bag 50K is omitted. As illustrated in FIG. 2 and FIG. 3, the tube support 51R and the tube support 51L are connected by link members 54R and 54L and 55R and 55L. When the walking assist device 10 is not in use as illustrated in FIG. 2 and FIG. 3, the space occupied by the walking assist device 10 is reduced by folding the walking assist device 10 as illustrated in FIG. 3. Thus, the walking assist device 10 is useful.

The state of the walking assist device 10 can be easily changed from the laterally folded state illustrated in FIG. 3 to the laterally unfolded state illustrated in FIG. 2. An elastically deformable coupler 53 is provided above the tube support 51R and the tube support 51L. A user enters a space between the tube 30R and the tube 30L from an open side (rear side) of the frame 50, and grips the handle 20R and the handle 20L by right and left hands to manipulate the walking assist device 10.

The tube 30L is held at the upper end of the tube support 51L. The wheel support 52L is fixed to the lower side of the tube support 51L. The tube support 51L is extensible and contractible in the up-and-down direction. Therefore, the height of the tube 30L is adjustable depending on the height of the hand of the user walking with his/her arm swinging. The front wheel 60FL, which is a turnable caster wheel, is provided on a front side of the wheel support 52L. The rear wheel 60RL, which is driven by the traveling drive unit 64L, is provided on a rear side of the wheel support 52L. The same applies to the tube support 51R, the tube 30R, the wheel support 52R, the front wheel 60FR, the traveling drive unit 64R, and the rear wheel 60RR. Therefore, description of those components is omitted. As described above, the frame 50 is provided with a plurality of wheels (front wheels 60FR and 60FL and rear wheels 60RR and 60RL), and at least one wheel (rear wheel 60RR and rear wheel 60RL in this case) is a driving wheel.

For example, the traveling drive unit 64R is an electric motor, and drives the rear wheel 60RR to rotate based on a control signal from the control device 40 that is generated based on electric power supplied from the battery B. For example, the traveling drive unit 64L is similarly an electric motor, and drives the rear wheel 60RL to rotate based on a control signal from the control device 40 that is generated based on electric power supplied from the battery B.

A traveling velocity detection unit 64RE such as an encoder is provided on the traveling drive unit 64R, and outputs a detection signal to the control device 40 depending on rotation of the traveling drive unit 64R. The control device 40 can detect the traveling velocity of the walking assist device 10 on the ground (traveling velocity of the rear wheel 60RR) based on the detection signal from the traveling velocity detection unit 64RE. Similarly, a traveling velocity detection unit 64LE such as an encoder is provided on the traveling drive unit 64L, and outputs a detection signal to the control device 40 depending on rotation of the traveling drive unit 64L. The control device 40 can detect the traveling velocity of the walking assist device 10 on the ground (traveling velocity of the rear wheel 60RL) based on the detection signal from the traveling velocity detection unit 64LE.

The tube 30R has a tubular shape to extend in the frame front-rear direction, and houses the shaft 21R extending in the frame front-rear direction so that the shaft 21R is movable in the frame front-rear direction. Similarly, the tube 30L has a tubular shape to extend in the frame front-rear direction, and houses the shaft 21L extending in the frame front-rear direction so that the shaft 21L is movable in the frame front-rear direction. The tube 30R and the tube 30L are provided in a pair at the right and left.

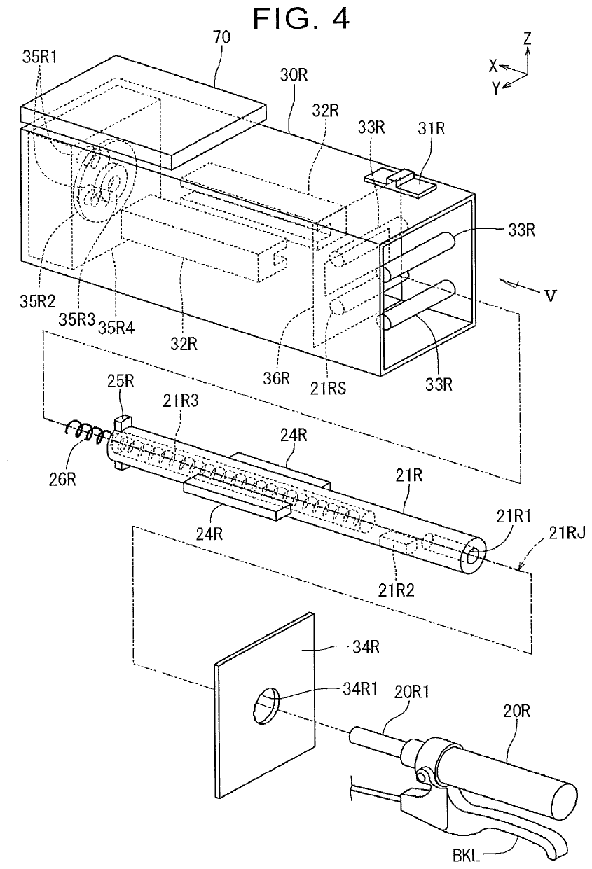

The shaft 21R has a tubular shape to extend in the frame front-rear direction, and at least a part of the shaft 21R is hollow (see FIG. 4). The shaft 21R is housed in the tube 30R, and is movable in the frame front-rear direction. The handle 20R is fixed to the rear end of the shaft 21R. Similarly, the shaft 21L has a tubular shape to extend in the frame front-rear direction, and at least a part of the shaft 21L is hollow. The shaft 21L is housed in the tube 30L, and is movable in the frame front-rear direction. The handle 20L is fixed to the rear end of the shaft 21L. The shaft 21R and the shaft 21L are provided in a pair at the right and left.

The handle 20R is a portion to be gripped by the right hand of the user, and is fixed to the rear end of the shaft 21R. The handle 20R is movable in the frame front-rear direction relative to the tube 30R (that is, relative to the frame 50) together with the shaft 21R in synchronization with a right arm swing along with the user's walk. The handle 20R is provided with a brake lever BKL configured to decelerate the rotation of the rear wheel 60RR. Similarly, the handle 20L is a portion to be gripped by the left hand of the user, and is fixed to the rear end of the shaft 21L. The handle 20L is movable in the frame front-rear direction relative to the tube 30L (that is, relative to the frame 50) together with the shaft 21L in synchronization with a left arm swing along with the user's walk. The handle 20L is provided with a brake lever BKL configured to decelerate the rotation of the rear wheel 60RL. The handle 20R and the handle 20L are provided in a pair at the right and left.

A handle condition detection unit 21LS is provided in the tube 30L, and can detect the condition of the handle 20L. For example, the handle condition detection unit 21LS is an encoder, which rotates in response to the movement of the shaft 21L in the frame front-rear direction and outputs a detection signal to the control device 40 depending on a position of the shaft 21L in the frame front-rear direction inside the tube 30L (that is, a position of the handle 20L in the frame front-rear direction). The control device 40 can determine a (left) fore-and-aft handle position, which is a position of the handle 20L in the frame front-rear direction relative to the frame 50 (relative to the tube 30L), based on the detection signal from the handle condition detection unit 21LS.

Similarly, a handle condition detection unit 21RS is provided in the tube 30R, and can detect the condition of the handle 20R. For example, the handle condition detection unit 21RS is an encoder, which rotates in response to the movement of the shaft 21R in the frame front-rear direction and outputs a detection signal to the control device 40 depending on a position of the shaft 21R in the frame front-rear direction inside the tube 30R (that is, a position of the handle 20R in the frame front-rear direction). The control device 40 can determine a (right) fore-and-aft handle position, which is a position of the handle 20R in the frame front-rear direction relative to the frame 50 (relative to the tube 30R), based on the detection signal from the handle condition detection unit 21RS

The tube 30R (30L) is provided with a locking portion 31R (31L) to be manipulated by the user. The locking portion 31R (31L) sets the shaft 21R (21L) and the handle 20R (20L) movable in the frame front-rear direction to a “locked state” or an “unlocked state”. In the “locked state”, a movement range of the shaft 21R (21L) and the handle 20R (20L) in the frame front-rear direction is limited to a fore-and-aft limit range W1 (see FIG. 8 to FIG. 10) near a reference shaft position. In the “unlocked state”, the movement range of the shaft 21R (21L) and the handle 20R (20L) is permitted to exceed the fore-and-aft limit range W1 (see FIG. 11).

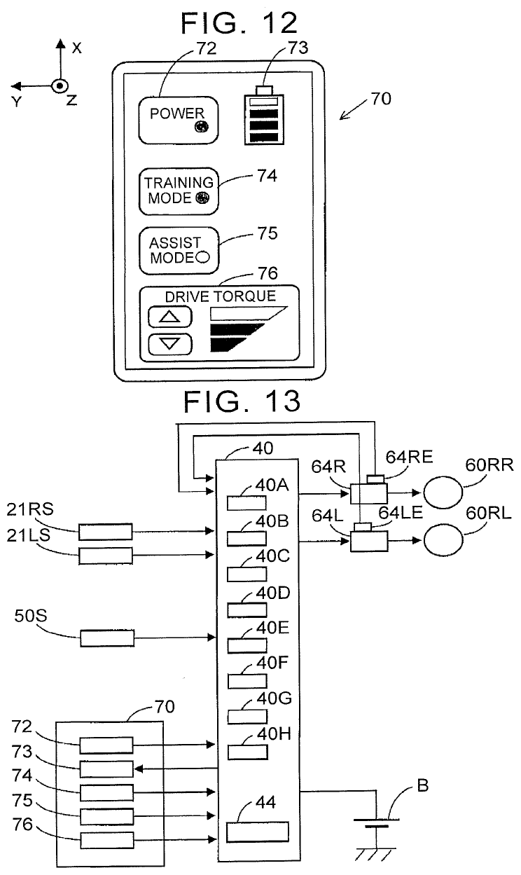

For example, an operation panel 70 is provided on an upper face of the tube 30R. As illustrated in FIG. 12, the operation panel 70 includes a main switch 72, a battery indicator 73, a training mode instruction part 74, an assist mode instruction part 75, and a drive torque adjustment part 76. Details of the operation panel 70 are described later.

A three-axis acceleration/angular velocity sensor 50S is provided on the frame 50. The three-axis acceleration/angular velocity sensor 50S measures accelerations on the three axes that are the X-axis, the Y-axis, and the Z-axis, measures angular velocities of rotations about the three axes, and outputs detection signals to the control device 40 based on measurement results. For example, if the walking assist device 10 is traveling along a slope, the three-axis acceleration/angular velocity sensor 50S outputs a detection signal to the control device 40 depending on tilt angles of the walking assist device 10 from the X-axis, the Y-axis, and the Z-axis. For example, the three-axis acceleration/angular velocity sensor 50S detects an acceleration applied on a body of the walking assist device 10 (for example, an impact on the body), and outputs a detection signal to the control device 40 depending on the detected acceleration. For example, the three-axis acceleration/angular velocity sensor 50S detects a pitch angular velocity (angular velocity about the Y-axis), a yaw angular velocity (angular velocity about the Z-axis), and a roll angular velocity (angular velocity about the X-axis) of the body of the walking assist device 10, and outputs a detection signal to the control device 40 depending on the detected angular velocities. The control device 40 can detect the tilt angles of the walking assist device 10 from the X-axis, the Y-axis, and the Z-axis, the magnitude of the acceleration (impact), the pitch angular velocity, the yaw angular velocity, and the roll angular velocity based on the detection signals from the three-axis acceleration/angular velocity sensor 50S.

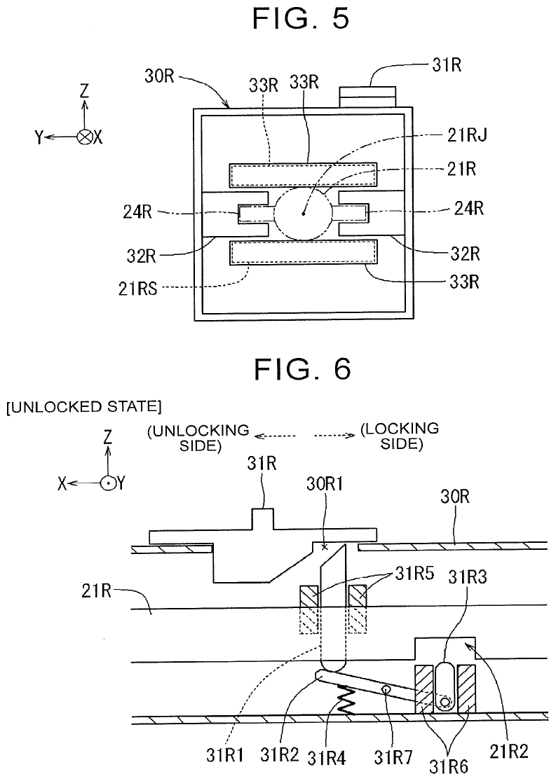

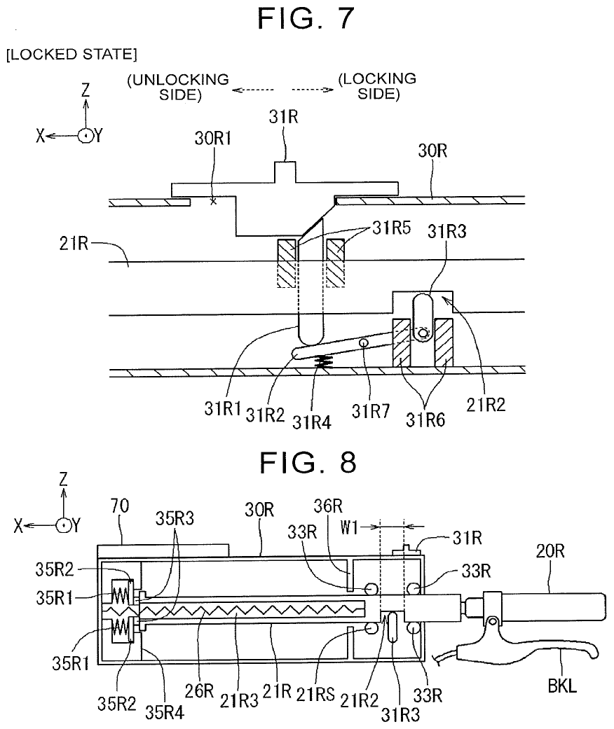

Next, details of the structures of the tubes and the shafts are described with reference to FIG. 4. Since the tubes and the shafts (and the handles) are provided in pairs at the right and left, the tube 30R, the shaft 21R, a lid 34R, and the handle 20R on the right side are described as examples, and description of the tube 30L, the shaft 21L, a lid, and the handle 20L on the left side (see FIG. 1) is omitted. FIG. 4 is a perspective view of the tube 30R, the shaft 21R, the lid 34R, and the handle 20R. FIG. 5 is a diagram of the tube 30R that is viewed in a direction V in FIG. 4. In FIG. 4 and FIG. 5, a locking mechanism (see FIG. 6 and FIG. 7) that interlocks with the locking portion 31R is omitted.

The tube 30R has the tubular shape to extend in the frame front-rear direction. Guiding rails 32R, guiding rollers 33R, the handle condition detection unit 21RS, an elastic unit 35R4, and the like are provided in the tube 30R. The locking portion 31R, the operation panel 70, and the like are provided on the upper face of the tube 30R. The shaft 21R has a handle fitting hole 21R1, a locking hole 21R2, a hollow portion 21R3, guided members 24R, a shaft-side elastic member 26R, retaining members 25R, and the like. The lid 34R has an insertion hole 34R1 through which the shaft 21R is inserted. The handle 20R has a shaft fitting portion 20R1, the brake lever BKL, and the like.

As illustrated in FIG. 8, one side (distal end in the X-axis direction) of the shaft-side elastic member 26R (that may be regarded as a shaft position recovery portion) is fixed to the tube 30R after the shaft 21R is inserted through the tube 30R. As illustrated in FIG. 8, the other side (distal end in the direction opposite to the X-axis direction) of the shaft-side elastic member 26R is inserted through the hollow portion 21R3 of the shaft 21R, and is fixed to the shaft 21R.

As illustrated in FIG. 8, the elastic unit 35R4 is fixed to a front end (distal end in the X-axis direction) in the tube 30R. The elastic unit 35R4 has tube-side elastic members 35R1 (that may be regarded as the shaft position recovery portion), a collar 35R2, a damper 35R3, and the like. As illustrated in FIG. 8, one side (distal end in the X-axis direction) of the tube-side elastic member 35R1 is fixed to the elastic unit 35R4. As illustrated in FIG. 8, the other side (distal end in the direction opposite to the X-axis direction) of the tube-side elastic member 35R1 is fixed to a front face of the collar 35R2. The damper 35R3 is attached to a rear face of the collar 35R2, and absorbs, for example, impact noise to be caused when the distal end of the shaft 21R strikes against the damper 35R3. At the reference shaft position illustrated in FIG. 8, the distal end of the shaft 21R is in contact with a rear side of the damper 35R3.

In FIG. 4, the shaft fitting portion 20R1 of the handle 20R is inserted through the insertion hole 34R1 of the lid 34R, and is fitted to the handle fitting hole 21R1 of the shaft 21R. Thus, the handle 20R and the shaft 21R are integrated together. The shaft 21R is turned clockwise by 90° about the X-axis, inserted into a space between the upper and lower guiding rollers 33R of the tube 30R, and pushed along the X-axis direction. The shaft 21R is turned counterclockwise by 90° about the X-axis before the retaining members 25R at the distal end of the shaft 21R reach the guiding rails 32R through a retaining panel 36R. When the shaft 21R is further pushed along the X-axis direction, the guided members 24R of the shaft 21R are inserted into recesses of the guiding rails 32R, and the shaft 21R is guided along the guiding rails 32R. The shaft 21R is inserted until a front distal end of the shaft 21R is brought into contact with the damper 35R3, and a front distal end of the shaft-side elastic member 26R is fixed to the tube 30R by an operator. The guiding rails 32R and the guided members 24R may be regarded as a rotation prevention structure that prevents rotation of the shaft 21R in the tube 30R about a shaft central axis 21RJ (see FIG. 4) extending in the frame front-rear direction.

Next, the structure of the locking mechanism is described with reference to FIG. 6 and FIG. 7. As illustrated in FIG. 6 and FIG. 7, the locking mechanism includes the locking portion 31R, a slider 31R1, a pivot member 31R2, a locking protrusion 31R3, an elastic member 31R4, and the like. FIG. 6 illustrates an example in which the locking mechanism is in the “unlocked state”. FIG. 7 illustrates an example in which the locking mechanism is in the “locked state”. The locking mechanisms are provided in a pair at the right and left. Therefore, the locking mechanism for the tube 30R and the shaft 21R is described, and description of the locking mechanism for the tube 30L and the shaft 21L is omitted.

FIG. 6 and FIG. 7 illustrate a state in which the user does not grip the handle 20R (see FIG. 1), the shaft 21R is held at the reference shaft position (see FIG. 8), and the locking protrusion 31R3 faces a locking hole 21R2. The locking hole 21R2 is preferably open downward so that dust or the like is not deposited.

The locking portion 31R is attached to a hole 30R1 formed in the tube 30R, and is slidable in the frame front-rear direction (X-axis direction) along the hole 30R1. The “unlocked state” is a state illustrated in FIG. 6, in which the user slides the locking portion 31R in the X-axis direction. The “locked state” is a state illustrated in FIG. 7, in which the user slides the locking portion 31R in the direction opposite to the X-axis direction.

The slider 31R1 is movable in the up-and-down direction along guiding members 31R5. An upward urging force is applied to a lower end of the slider 31R1 from one end side of the pivot member 31R2 and the elastic member 31R4. In the “unlocked state” illustrated in FIG. 6, the slider 31R1 moves upward by receiving the upward urging force from the one end side of the pivot member 31R2 and the elastic member 31R4. In the “locked state” illustrated in FIG. 7, the slider 31R1 is pushed downward by the locking portion 31R, and pushes the one end side of the pivot member 31R2 downward.

The one end side of the pivot member 31R2 is in contact with the lower end of the slider 31R1, and the pivot member 31R2 receives the upward urging force from the elastic member 31R4, and is pivotable about a fulcrum 31R7. The locking protrusion 31R3 is connected to the other end side of the pivot member 31R2. Since the slider 31R1 moves upward in the “unlocked state” illustrated in FIG. 6, the one end side of the pivot member 31R2 is pushed upward by the elastic member 31R4, and the other end side of the pivot member 31R2 moves downward. Since the slider 31R1 is pushed downward in the “locked state” illustrated in FIG. 7, the one end side of the pivot member 31R2 is pushed downward by the slider 31R1, and the other end side of the pivot member 31R2 moves upward.

The locking protrusion 31R3 is movable in the up-and-down direction along guiding members 31R6. A lower end side of the locking protrusion 31R3 is connected to the other end side of the pivot member 31R2. Since the other end side of the pivot member 31R2 moves downward in the “unlocked state” illustrated in FIG. 6, the locking protrusion 31R3 is located away from the locking hole 21R2 of the shaft 21R. Since the other end side of the pivot member 31R2 moves upward in the “locked state” illustrated in FIG. 7, the locking protrusion 31R3 is inserted into the locking hole 21R2 of the shaft 21R.

Description is provided on a movable range of the shaft 21R in the locked state (FIG. 8 to FIG. 10) and a movable range of the shaft 21R in the unlocked state (FIG. 11). FIG. 8 illustrates an example in which the user does not grip the handle 20R and the locking mechanism is in the “locked state”. FIG. 8 illustrates an example of a state in which the positions of the shaft 21R and the handle 20R in the frame front-rear direction (X-axis direction) relative to the tube 30R are kept at the reference shaft position. In FIG. 8 to FIG. 11, details of the locking mechanism are omitted, and the “locked state” and the “unlocked state” are indicated by the locking protrusion 31R3. If a force in the front-rear direction (direction parallel to the X-axis direction) is not applied to the handle 20R, the shaft 21R and the handle 20R are held at the reference shaft position illustrated in FIG. 8 irrespective of whether the locking mechanism is in the “locked state” or the “unlocked state”. In this case, the shaft-side elastic member 26R (that may be regarded as the shaft position recovery portion) and the tube-side elastic members 35R1 (that may be regarded as the shaft position recovery portion) hold the shaft 21R and the handle 20R at the reference shaft position illustrated in FIG. 8.

At the reference shaft position illustrated in FIG. 8, both the shaft-side elastic member 26R and the tube-side elastic member 35R1 have free lengths (lengths at which no force is applied), or are set so that a force for pulling the shaft 21R forward by the shaft-side elastic member 26R is balanced with a force for pushing the shaft 21R rearward by the tube-side elastic member 35R1. The length of the shaft-side elastic member 26R and the length of the tube-side elastic member 35R1 are adjusted so that, at the reference shaft position, the locking protrusion 31R3 is located at a substantially central position within the fore-and-aft limit range W1, which is a range of the fore-and-aft length of the locking hole 21R2 provided in the shaft 21R. Spring rates (i.e., spring constants) are set so that a spring rate K35 of the tube-side elastic member 35R1 is higher than a spring rate K26 of the shaft-side elastic member 26R. For example, as illustrated in FIG. 8, the reference shaft position is substantially close to the front end in the movable range of the shaft 21R in the frame front-rear direction.

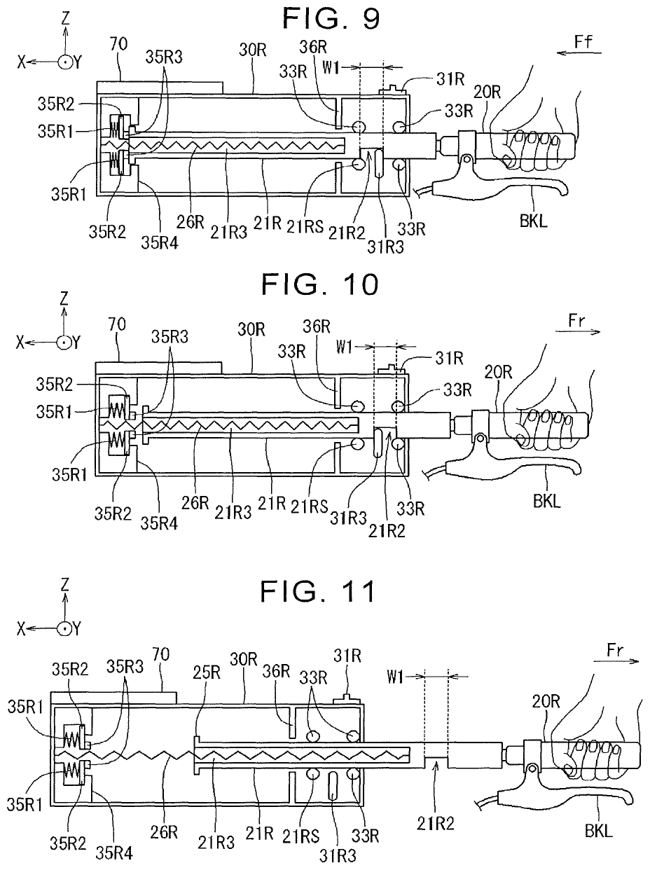

As illustrated in FIG. 9, when the user grips the handle 20R in the “locked state” illustrated in FIG. 8 and pushes the handle 20R forward (X-axis direction) by a force Ff, the shaft 21R and the handle 20R are movable forward until the locking protrusion 31R3 contacts a rear edge of the locking hole 21R2. When the user releases the hand from the handle 20R in the state illustrated in FIG. 9, the shaft 21R and the handle 20R are returned to the reference shaft position illustrated in FIG. 8 by an elastic force of the tube-side elastic member 35R1.

As illustrated in FIG. 10, when the user grips the handle 20R in the “locked state” illustrated in FIG. 8 and pulls the handle 20R rearward (direction opposite to the X-axis direction) by a force Fr, the shaft 21R and the handle 20R are movable rearward until the locking protrusion 31R3 contacts a front edge of the locking hole 21R2. When the user releases the hand from the handle 20R in the state illustrated in FIG. 10, the shaft 21R and the handle 20R are returned to the reference shaft position illustrated in FIG. 8 by an elastic force of the shaft-side elastic member 26R.

As illustrated in FIG. 11, in the “unlocked state”, the movement range of the shaft 21R in the frame front-rear direction is not limited to the fore-and-aft limit range W1. Thus, when the user grips the handle 20R and pulls the handle 20R rearward by the force Fr, the handle 20R can be pulled rearward until the retaining members 25R at the distal end of the shaft 21R interfere with the retaining panel 36R. That is, in the “unlocked state” illustrated in FIG. 11, the user can walk with his/her arm swinging greatly by using the walking assist device 10. The retaining member 25R and the retaining panel 36R may be regarded as a retaining structure that prevents detachment of the shaft 21R from the tube 30R.

As described above, the reference shaft position is set for the shaft 21R (shaft 21L). The reference shaft position is a reference position in the frame front-rear direction relative to the tube 30R (tube 30L) that houses the shaft 21R (shaft 21L). If the user does not grip the handle 20R as illustrated in FIG. 8, the shaft 21R and the handle 20R are held at the reference shaft position by the shaft position recovery portion (shaft-side elastic member 26R and tube-side elastic member 35R1). If the shaft 21R and the handle 20R are held at the reference shaft position as illustrated in FIG. 8, the locking protrusion 31R3 faces a substantially central position in the locking hole 21R2 in the frame front-rear direction. In the “locked state”, the shaft 21R is held within the fore-and-aft limit range W1 in the frame front-rear direction so that the shaft 21R is located near the reference shaft position.

In FIG. 8 to FIG. 10, the distance from the locking protrusion 31R3 to the front edge or the rear edge of the locking hole 21R2 is relatively enlarged for clarity. The distance from the locking protrusion 31R3 to the front edge or the rear edge of the locking hole 21R2 is sufficient if the distance is about 1 [mm]. In the “unlocked state”, the user can pull the shaft 21R rearward by, for example, about 150 [mm] from the reference shaft position illustrated in FIG. 8.

Next, (the appearance of) the operation panel 70 is described with reference to FIG. 12. In the example described in this embodiment, the operation panel 70 is provided on the upper face of the tube 30R. As illustrated in FIG. 12, the operation panel 70 includes the main switch 72, the battery indicator 73, the training mode instruction part 74, the assist mode instruction part 75, and the drive torque adjustment part 76.

The main switch 72 is used for instructing the walking assist device 10 to start. When the user turns ON the main switch 72, the battery B supplies electric power to the control device 40 and the traveling drive units 64R and 64L, thereby enabling manipulation and operation of the walking assist device 10. The battery indicator 73 indicates the remaining power of the battery B.

The drive torque adjustment part 76 is an input part to be used by the user for adjusting the magnitude of drive torques of the traveling drive units 64R and 64L when the walking assist device 10 travels. For example, if the walking assist device 10 is used on an upward slope, the user inputs an instruction to increase the drive torques on the drive torque adjustment part 76.

Two operation modes are prepared in the walking assist device 10. The first mode is a “training mode” for assisting “arm swinging walk”. In the arm swinging walk, the user walks with his/her arms swinging. The second mode is an “assist mode” for assisting the user in walking without swinging his/her arms as if the user pushed a hand cart (non-arm swinging walk). If the user desires the “arm swinging walk”, the user manipulates the training mode instruction part 74 to set the operation mode to the “training mode”, manipulates the locking portions 31R and 31L into the “unlocked state”, and grips the right and left handles 20R and 20L to walk with his/her arms swinging. Thus, the user starts the “arm swinging walk”. If the user desires the “non-arm swinging walk”, the user manipulates the assist mode instruction part 75 to set the operation mode to the “assist mode”, manipulates the locking portions 31R and 31L into the “locked state”, and grips the right and left handles 20R and 20L to walk without swinging his/her arms. Thus, the user starts the “non-arm swinging walk”.

FIG. 13 is a block diagram illustrating input and output of the control device 40. The control device 40 includes a control unit such as a central processing unit (CPU) (not illustrated), and a storage unit 44. That is, the control device 40 is an electronic control unit. Detection signals from the traveling velocity detection units 64RE and 64LE, detection signals from the handle condition detection units 21RS and 21LS, and detection signals from the three-axis acceleration/angular velocity sensor 50S are input to the control device 40. Further, manipulation conditions of the main switch 72, the training mode instruction part 74, the assist mode instruction part 75, and the drive torque adjustment part 76 are input to the control device 40 from the operation panel 70. The control device 40 outputs, to the operation panel 70, remaining battery power information to be indicated by the battery indicator 73 of the operation panel 70, and outputs control signals to the traveling drive units 64R and 64L.

The control device 40 includes a device ground velocity calculation unit 40A, a fore-and-aft handle position calculation unit 40B, a handle moving velocity calculation unit 40C, a handle ground velocity calculation unit 40D, a ground velocity correction amount calculation unit 40E, a traveling velocity adjustment unit 40F, a fore-and-aft central handle position calculation unit 40G, and a central position velocity correction amount calculation unit 40H. Those components are described later.

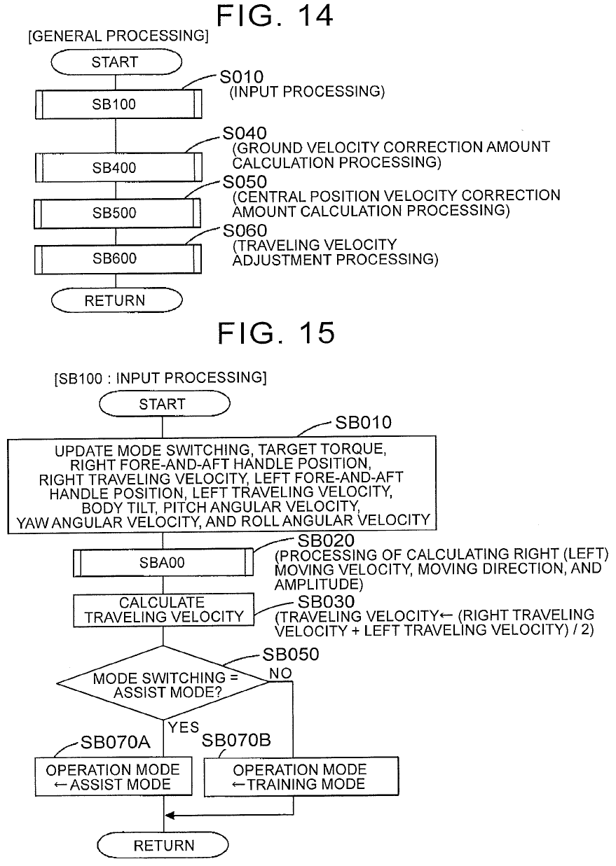

A processing procedure of the control device 40 (FIG. 14 to FIG. 19) is described. FIG. 14 illustrates general processing in the processing procedure of the control device 40. When the user turns ON the main switch 72, the processing illustrated in FIG. 14 is started at predetermined time intervals (for example, intervals of several milliseconds). When the processing illustrated in FIG. 14 is started, the control device 40 advances the processing to Step S010. Description is given below of an example in which the user walks forward together with the walking assist device.

In Step S010, the control device 40 executes SB100 (input processing), and advances the processing to Step S040. Details of SB100 (input processing) are described later.

In Step S040, the control device 40 executes SB400 (ground velocity correction amount calculation processing), and advances the processing to Step S050. Details of SB400 (ground velocity correction amount calculation processing) are described later.

In Step S050, the control device 40 executes SB500 (central position velocity correction amount calculation processing), and advances the processing to Step S060. Details of SB500 (central position velocity correction amount calculation processing) are described later.

In Step S060, the control device 40 executes SB600 (traveling velocity adjustment processing), and terminates (returns) the processing. Details of SB600 (traveling velocity adjustment processing) are described later.

Next, details of SB100 (input processing) are described with reference to FIG. 15. When SB100 is executed in Step S010 illustrated in FIG. 14, the control device 40 advances the processing to Step SB010 illustrated in FIG. 15.

In Step SB010, the control device 40 updates mode switching, a target torque, a right fore-and-aft handle position, a right traveling velocity, a left fore-and-aft handle position, a left traveling velocity, a body tilt, a pitch angular velocity, a yaw angular velocity, and a roll angular velocity that are stored in the storage unit. Then, the control device 40 advances the processing to Step SB020.

Specifically, the control device 40 stores the “training mode” or the “assist mode” as the mode switching based on information input from the training mode instruction part 74 and the assist mode instruction part 75 (see FIG. 12). The control device 40 stores the target torque based on information input from the drive torque adjustment part 76 (see FIG. 12). The control device 40 stores, as the right fore-and-aft handle position, the position of the handle 20R relative to the frame 50 (position in the frame front-rear direction) that is determined based on a detection signal from the handle condition detection unit 21RS (see FIG. 1). The control device 40 stores the right traveling velocity by detecting a rotation velocity of the (right) traveling drive unit 64R based on a detection signal from the (right) traveling velocity detection unit 64RE of the (right) traveling drive unit 64R and detecting a traveling velocity of the rear wheel 60RR based on the rotation velocity of the rear wheel 60RR (see FIG. 1).

Similarly, the control device 40 stores the left fore-and-aft handle position and the left traveling velocity. The control device 40 stores, as the body tilt, tilt information such as a tilt angle and a tilt direction of the body of the walking assist device 10 that are determined based on detection signals from the three-axis acceleration/angular velocity sensor 50S (see FIG. 1). The control device 40 stores an angular velocity of the walking assist device 10 about the Y-axis as the pitch angular velocity, an angular velocity of the walking assist device 10 about the Z-axis as the yaw angular velocity, and an angular velocity of the walking assist device 10 about the X-axis as the roll angular velocity. Those angular velocities are determined based on detection signals from the three-axis acceleration/angular velocity sensor 505 (see FIG. 1).

The control device 40 that executes the processing of Step SB010 corresponds to the fore-and-aft handle position calculation unit 40B (see FIG. 13) configured to calculate the fore-and-aft handle positions (right fore-and-aft handle position and left fore-and-aft handle position), which are positions of the handles 20R and 20L in the frame front-rear direction relative to the frame 50 (walking assist device 10), based on the detection signals from the handle condition detection units 21RS and 21LS.

In Step SB020, the control device 40 executes SBA00 (processing of calculating a right (left) moving velocity, a moving direction, and an amplitude), and advances the processing to Step SB030. Details of SBA00 (processing of calculating a right (left) moving velocity, a moving direction, and an amplitude) are described later.

In Step SB030, the control device 40 stores the traveling velocity of the walking assist device that is determined based on the right traveling velocity and the left traveling velocity stored in Step SB010, and advances the processing to Step SB050. For example, the control device 40 determines the traveling velocity based on an expression “traveling velocity=(right traveling velocity+left traveling velocity)/2”.

The control device 40 that executes the processing of Step SB030 corresponds to the device ground velocity calculation unit 40A (see FIG. 13) configured to calculate the traveling velocity of the walking assist device 10 on the ground based on the detection signals from the traveling velocity detection units.

In Step SB050, the control device 40 determines whether the mode switching to the assist mode is performed. When the mode switching to the assist mode is performed (Yes), the control device 40 advances the processing to Step SB070A. When the mode switching to the assist mode is not performed (No), the control device 40 advances the processing to Step SB070B.

When the processing advances to Step SB070A, the control device 40 stores the assist mode as the operation mode, and terminates (returns) the processing.

When the processing advances to Step SB070B, the control device 40 stores the training mode as the operation mode, and terminates (returns) the processing.

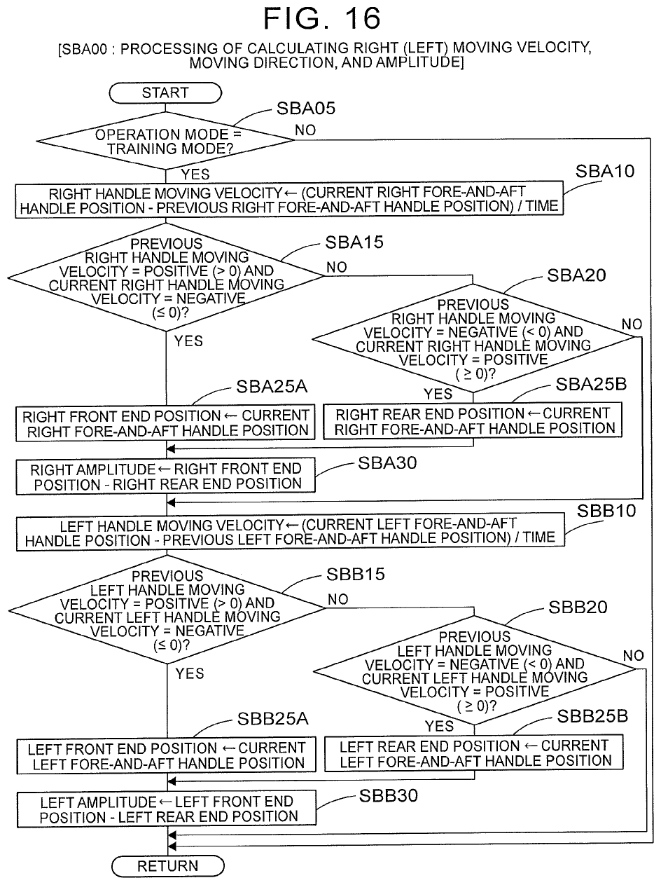

Next, details of SBA00 (processing of calculating a right (left) moving velocity, a moving direction, and an amplitude) are described with reference to FIG. 16. When SBA00 is executed in Step SB020 illustrated in FIG. 15, the control device 40 advances the processing to Step SBA05 illustrated in FIG. 16.

In Step SBA05, the control device 40 determines whether the operation mode is the training mode. When the operation mode is the training mode (Yes), the control device 40 advances the processing to Step SBA10. When the operation mode is not the training mode (No), the control device 40 terminates (returns) the processing.

When the processing advances to Step SBA10, the control device 40 stores, as a right handle moving velocity, a velocity determined based on an expression “(right fore-and-aft handle position in current processing (current right fore-and-aft handle position)—right fore-and-aft handle position in previous processing (previous right fore-and-aft handle position))/time”. Then, the control device 40 advances the processing to Step SBA15. In this case, the “time” is a time interval at which the processing of FIG. 14 is started (for example, 10 (ms) when the processing is started at intervals of 10 (ms)). If the current right fore-and-aft handle position is in front of the previous right fore-and-aft handle position, the right handle moving velocity is a “positive” velocity. If the current right fore-and-aft handle position is behind the previous right fore-and-aft handle position, the right handle moving velocity is a “negative” velocity.

In Step SBA15, the control device 40 determines whether the right handle moving velocity in the previous processing (previous right handle moving velocity) is positive (larger than 0) and the right handle moving velocity in the current processing (current right handle moving velocity) is negative (equal to or smaller than 0). When this condition is satisfied (Yes), the control device 40 advances the processing to Step SBA25A. When this condition is not satisfied (No), the control device 40 advances the processing to Step SBA20.

When the processing advances to Step SBA25A, the control device 40 stores the current right fore-and-aft handle position as a right front end position, and advances the processing to Step SBA30.

When the processing advances to Step SBA20, the control device 40 determines whether the right handle moving velocity in the previous processing (previous right handle moving velocity) is negative (smaller than 0) and the right handle moving velocity in the current processing (current right handle moving velocity) is positive (equal to or larger than 0). When this condition is satisfied (Yes), the control device 40 advances the processing to Step SBA25B. When this condition is not satisfied (No), the control device 40 advances the processing to Step SBB10.

When the processing advances to Step SBA25B, the control device 40 stores the current right fore-and-aft handle position as a right rear end position, and advances the processing to Step SBA30.

When the processing advances to Step SBA30, the control device 40 stores, as a right amplitude, a length determined based on an expression “right front end position—right rear end position (right front end position>right rear end position)”. Then, the control device 40 advances the processing to Step SBB10.

Processing of Steps SBB10 to SBB30 is processing of determining a left moving velocity, a left front end position, a left rear end position, and a left amplitude of the left handle 20L, and is similar to Steps SBA10 to SBA30 of determining the right moving velocity, the right front end position, the right rear end position, and the right amplitude of the right handle 20R. Therefore, description is omitted.

The control device 40 that executes the processing of Steps SBA10 and SBB10 corresponds to the handle moving velocity calculation unit 40C (see FIG. 13) configured to calculate the handle moving velocities (right handle moving velocity and left handle moving velocity), which are moving velocities of the handles relative to the walking assist device 10, based on the fore-and-aft handle positions (right fore-and-aft handle position and left fore-and-aft handle position).

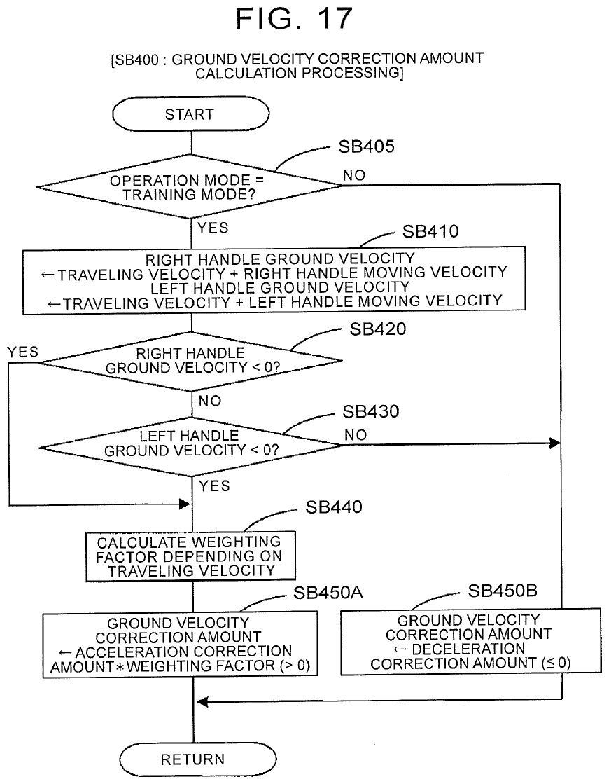

Next, details of SB400 (ground velocity correction amount calculation processing) are described with reference to FIG. 17. When SB400 is executed in Step S040 illustrated in FIG. 14, the control device 40 advances the processing to Step SB405 illustrated in FIG. 17.

In Step SB405, the control device 40 determines whether the operation mode is the training mode. When the operation mode is the training mode (Yes), the control device 40 advances the processing to Step SB410. When the operation mode is not the training mode (No), the control device 40 advances the processing to Step SB450B.

In Step SB410, the control device 40 stores a right handle ground velocity determined based on an expression “traveling velocity +right handle moving velocity”, and a left handle ground velocity determined based on an expression “traveling velocity+left handle moving velocity”. Then, the control device 40 advances the processing to Step SB420. The “traveling velocity” is a velocity of the walking assist device relative to the ground. The “right handle moving velocity” is a moving velocity of the (right) handle 20R in the frame front-rear direction relative to the walking assist device. The “right handle ground velocity” is a moving velocity of the (right) handle 20R in the frame front-rear direction relative to the ground. The “right handle moving velocity” is set to a “positive” velocity when the direction is identical to that of the “traveling velocity”, and is set to a “negative” velocity when the direction is opposite to that of the “traveling velocity”. That is, when the traveling velocity is a forward velocity, a forward right handle moving velocity is “positive”, and a rearward right handle moving velocity is “negative”. The left handle ground velocity is determined similarly.

The control device 40 that executes the processing of Step SB410 corresponds to the handle ground velocity calculation unit 40D (see FIG. 13) configured to calculate the handle ground velocities (right handle ground velocity and left handle ground velocity), which are velocities of the handles relative to the ground, based on the moving velocities of the handles and the traveling velocity.

In Step SB420, the control device 40 determines whether the right handle ground velocity is negative (smaller than 0). When the right handle ground velocity is negative (smaller than 0) (Yes), the control device 40 advances the processing to Step SB440. When the right handle ground velocity is not negative (No), the control device 40 advances the processing to Step SB430.

When the processing advances to Step SB430, the control device 40 determines whether the left handle ground velocity is negative (smaller than 0). When the left handle ground velocity is negative (smaller than 0) (Yes), the control device 40 advances the processing to Step SB440. When the left handle ground velocity is not negative (No), the control device 40 advances the processing to Step SB450B.

When the processing advances to Step SB440, the control device 40 calculates a weighting factor depending on the traveling velocity, and advances the processing to Step SB450A. For example, the weighting factor is set so as to decrease as the traveling velocity increases.

In Step SB450A, the control device 40 stores, as a ground velocity correction amount, a value obtained by multiplying a preset acceleration correction amount by the weighting factor, and terminates (returns) the processing. The acceleration correction amount is determined based on various experiments or simulations. In this case, the ground velocity correction amount is a value larger than 0 (correction amount that is a positive value and is calculated for acceleration).

The control device 40 that executes the processing of Steps SB440 and SB450A corresponds to the ground velocity correction amount calculation unit 40E (see FIG. 13) configured to calculate the ground velocity correction amount for accelerating the walking assist device 10 in the direction of the traveling velocity when at least one of the handle ground velocities of the handles is a “negative” velocity, provided that the traveling velocity is “positive”.

When the processing advances to Step SB450B, the control device 40 stores a preset deceleration correction amount as the ground velocity correction amount, and terminates (returns) the processing. The deceleration correction amount is determined based on various experiments or simulations. In this case, the ground velocity correction amount is a value equal to or smaller than 0 (correction amount that is 0 or a negative value and is calculated for deceleration).

When the ground velocity correction amount is a positive value larger than 0, the traveling velocity of the walking assist device can be increased. When the ground velocity correction amount is a negative value smaller than 0, the traveling velocity of the walking assist device can be reduced. When the ground velocity correction amount is 0, the walking assist device coasts, but the traveling velocity is reduced due to a rolling resistance or the like.

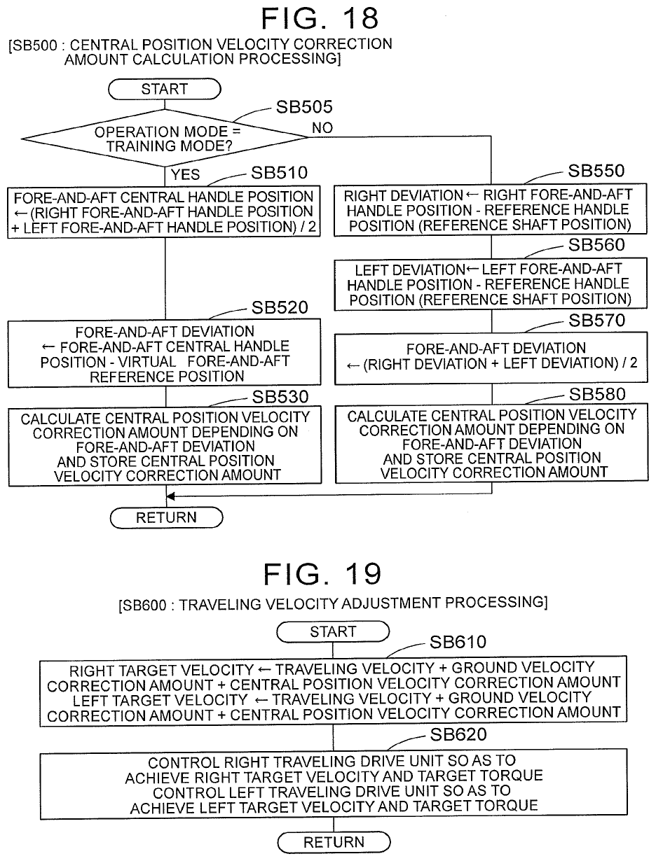

Next, details of SB500 (central position velocity correction amount calculation processing) are described with reference to FIG. 18. When SB500 is executed in Step S050 illustrated in FIG. 14, the control device 40 advances the processing to Step SB505 illustrated in FIG. 18.

In Step SB505, the control device 40 determines whether the operation mode is the training mode. When the operation mode is the training mode (Yes), the control device 40 advances the processing to Step SB510. When the operation mode is not the training mode (No), the control device 40 advances the processing to Step SB550.

When the processing advances to Step SB510, the control device 40 stores a fore-and-aft central handle position determined based on an expression “(right fore-and-aft handle position+left fore-and-aft handle position)/2”. Then, the control device 40 advances the processing to Step SB520.

The control device 40 that executes the processing of Step SB510 corresponds to the fore-and-aft central handle position calculation unit 40G (see FIG. 13) configured to determine the fore-and-aft central handle position, which is the center of the fore-and-aft handle positions in the frame front-rear direction.

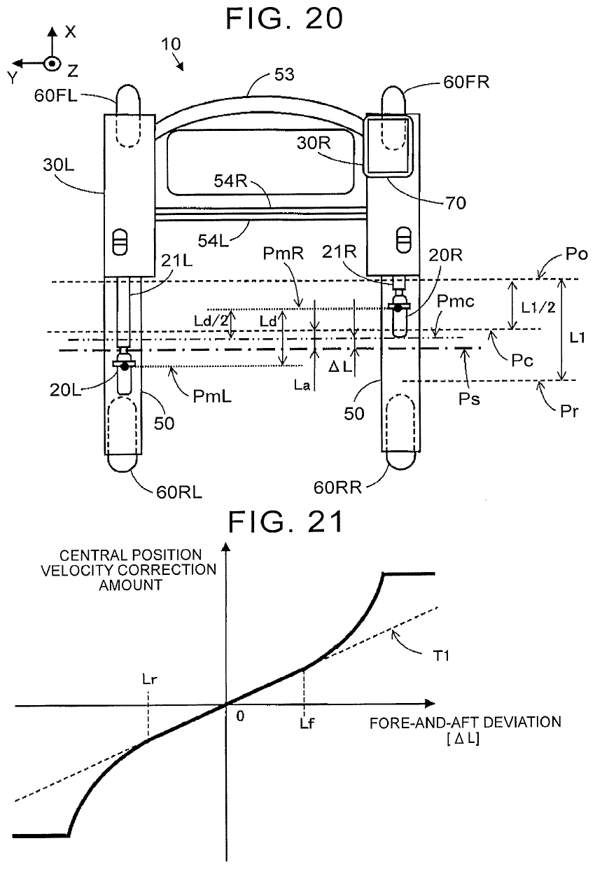

FIG. 20 is a plan view of the walking assist device 10, for describing a fore-and-aft handle position (PmR) of the (right) handle 20R, a fore-and-aft handle position (PmL) of the (left) handle 20L, a virtual fore-and-aft reference position (Ps), a fore-and-aft central handle position (Pmc), and a central position (Pc) of the movable range (movement range of each of the shafts 21R and 21L in the frame front-rear direction). For example, a movable range L1 of each of the handles 20R and 20L in the frame front-rear direction is defined from a front end position (Po) of the movable range L1 to a rear end position (Pr) of the movable range. The central position (Pc) is a central position of the movable range L1 in the frame front-rear direction. For example, a position behind the central position (Pc) of the movable range L1 by a predetermined distance La is set as the virtual fore-and-aft reference position (Ps), which is a predetermined position in the frame front-rear direction. A central position between the right fore-and-aft handle position (PmR) and the left fore-and-aft handle position (PmL) in the frame front-rear direction is the fore-and-aft central handle position (Pmc).

In Step SB520, the control device 40 stores a fore-and-aft deviation determined based on an expression “fore-and-aft central handle position—virtual fore-and-aft reference position”. Then, the control device 40 advances the processing to Step SB530. As illustrated in FIG. 20, a fore-and-aft deviation AL is a deviation between the fore-and-aft central handle position (Pmc) and the virtual fore-and-aft reference position (Ps).

In Step SB530, the control device 40 determines a central position velocity correction amount depending on the fore-and-aft deviation, stores the determined central position velocity correction amount, and terminates (returns) the processing. For example, the storage unit stores a fore-and-aft deviation-central position velocity correction amount characteristic illustrated in FIG. 21, and the control device 40 stores the central position velocity correction amount determined based on the fore-and-aft deviation-central position velocity correction amount characteristic and the fore-and-aft deviation.

When the processing advances to Step SB550, the control device 40 stores a right deviation determined based on an expression “right fore-and-aft handle position—reference handle position (position of the handle 20R corresponding to the reference shaft position)”. Then, the control device 40 advances the processing to Step SB560. When the operation mode is the “assist mode”, the locking mechanisms are in the “locked state”, and therefore the user cannot walk with his/her arms swinging while gripping the handles. In the “assist mode”, when the handles are pushed forward, the walking assist device 10 is accelerated forward through central position velocity correction in Steps SB550 to SB580.

In Step SB560, the control device 40 stores a left deviation determined based on an expression “left fore-and-aft handle position—reference handle position (position of the handle 20L corresponding to the reference shaft position)”. Then, the control device 40 advances the processing to Step SB570.

In Step SB570, the control device 40 stores a fore-and-aft deviation determined based on an expression “(right deviation+left deviation)/2”. Then, the control device 40 advances the processing to Step SB580.

In Step SB580, the control device 40 determines a central position velocity correction amount depending on the fore-and-aft deviation, stores the determined central position velocity correction amount, and terminates (returns) the processing. For example, the storage unit stores the fore-and-aft deviation-central position velocity correction amount characteristic illustrated in FIG. 21, and the control device 40 stores the central position velocity correction amount determined based on the fore-and-aft deviation-central position velocity correction amount characteristic and the fore-and-aft deviation. It is more preferable that the central position velocity correction amount in the locked state (Step SB580) should be larger than the central position velocity correction amount in the unlocked state (Step SB530) even if the fore-and-aft deviation in the locked state is the same as the fore-and-aft deviation in the unlocked state.

The control device 40 that executes the processing of Steps SB520, SB530, SB570, and SB580 corresponds to the central position velocity correction amount calculation unit 40H (see FIG. 13) configured to calculate the central position velocity correction amount for adjusting the traveling velocity of the walking assist device 10 so that the fore-and-aft central handle position moves closer to the virtual fore-and-aft reference position in the frame front-rear direction.

Next, details of SB600 (traveling velocity adjustment processing) are described with reference to FIG. 19. When SB600 is executed in Step S060 illustrated in FIG. 14, the control device 40 advances the processing to Step SB610 illustrated in FIG. 19.

In Step SB610, the control device 40 stores a right target velocity determined based on an expression “traveling velocity+ground velocity correction amount+central position velocity correction amount”, and a left target velocity determined based on an expression “traveling velocity+ground velocity correction amount+central position velocity correction amount”. Then, the control device 40 advances the processing to Step SB620.

In Step SB620, the control device 40 controls the (right) traveling drive unit 64R so as to achieve the right target velocity and the target torque, and controls the (left) traveling drive unit 64L so as to achieve the left target velocity and the target torque. Then, the control device 40 terminates (returns) the processing.

The control device 40 that executes the processing of Steps SB610 and SB620 corresponds to the traveling velocity adjustment unit 40F (see FIG. 13) configured to control the traveling drive units so as to achieve the target velocities determined based on the traveling velocity and the ground velocity correction amount (and the central position velocity correction amount).

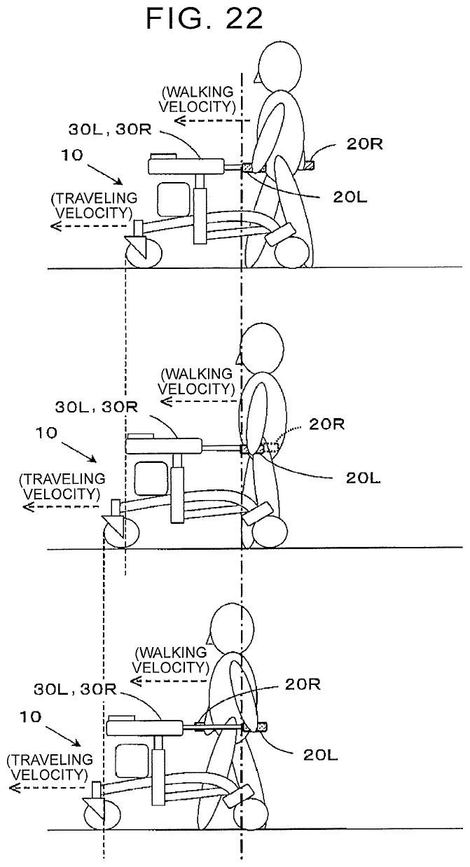

FIG. 22 illustrates an example of a state in which the user grips the (right) handle 20R by the right hand, grips the (left) handle 20L by the left hand, and walks with his/her left arm swinging from the front to the rear (the right arm is swung from the rear to the front).

When the (left) handle 20L moves rearward and when the (left) handle ground velocity that is a moving velocity of the (left) handle 20L relative to the ground is “negative”, the walking assist device 10 is accelerated forward based on the ground velocity correction amount. Therefore, the (left) handle 20L appears stationary in relation to the ground as indicated by an alternate long and short dash line in FIG. 22. That is, the walking assist device 10 travels while adjusting the traveling velocity so that the (left) handle 20L moved rearward appears stationary in relation to the ground.

Effects of the disclosure are described. As described above, the walking assist device 10 described in this embodiment can simulate an arm swinging walk action by adjusting the traveling velocity using the ground velocity correction amount. Thus, the walking assist device 10 can assist the user in training himself/herself to walk with his/her arms swinging and his/her body trunk kept straight. The walking assist device 10 described in this embodiment adjusts the traveling velocity using the central position velocity correction amount so that the user stays near the virtual fore-and-aft reference position, while the walking assist device 10 travels. Thus, it is possible to appropriately prevent the position of the walking assist device in the front-rear direction from deviating from that of the user.

The handles 20R and 20L are movable in the frame front-rear direction owing to the tubes 30R and 30L and the shafts 21R and 21L. Thus, the walking assist device 10 can appropriately assist, with a very simple structure, high-quality walk training in which the user walks with his/her arms properly swinging in synchronization with legs.

The walking assist device of the disclosure is not limited to the configurations, structures, shapes, processing procedures, and other features described in this embodiment, and various kinds of modification, addition, or deletion may be made without changing the scope of the disclosure.

In this embodiment, description is provided on the example in which the walking assist device having a plurality of wheels is a four-wheel device provided with two driving wheels. The walking assist device may be a three-wheel device having one front wheel and two rear wheels, in which the front wheel is a driving wheel and the two rear wheels are caster wheels. That is, the walking assist device needs to have at least one driving wheel. In this embodiment, description is provided on the example in which the “traveling velocity” is adjusted in the control over the traveling drive unit (electric motor). The disclosure is not limited to the “velocity” control. Alternatively, “torque” control may be adopted and the traveling velocity may be adjusted by controlling a motor torque.

The handle condition detection units 21RS and 21LS configured to detect the conditions (positions) of the handles 20R and 20L and the traveling velocity detection units 64RE and 64LE configured to detect the traveling velocities are not limited to the encoders, but may adopt various structures and arrangements without being limited to the structures and arrangements described in this embodiment. Description is provided on the example in which the shaft-side elastic member 26R and the tube-side elastic members 35R1 (see FIG. 8) are used as the shaft position recovery portion. The shaft position recovery portion is not limited to those members.

In this embodiment, description is provided on the example in which the traveling velocity is adjusted by using the ground velocity correction amount and the central position velocity correction amount. The central position velocity correction amount may be omitted, and the traveling velocity may be adjusted by using the ground velocity correction amount. Alternatively, the ground velocity correction amount may be omitted, and the traveling velocity may be adjusted by using the central position velocity correction amount. In this embodiment, description is provided on the example in which the ground velocity correction amount decreases as the traveling velocity increases. The disclosure is not limited to this example.

The retaining structure (retaining members 25R and retaining panel 36R (see FIG. 11)) that prevents detachment of the shaft from the tube and the rotation prevention structure (guiding rails 32R and guided members 24R (see FIG. 4)) that prevents rotation of the shaft in the tube may adopt various structures, and are not limited to the structures described in this embodiment.

The phrases “equal to or larger than (≥)”, “equal to or smaller than (23)”, “larger than (>)”, and “smaller than (<)” may include an equal sign, and may not include the equal sign. The numerical values used in the description of this embodiment are examples, and the disclosure is not limited to those numerical values.

What is claimed is:

1. A walking assist device comprising:
a frame;
a plurality of wheels provided on the frame and including at least one driving wheel;
at least one traveling drive unit configured to drive the at least one driving wheel;
a battery configured to operate the at least one traveling drive unit;
a pair of right and left handles configured to be gripped by a user to move in a frame front-rear direction that is a front-rear direction of the frame;
handle condition detection units configured to detect conditions of the respective handles;
an electronic control unit configured to control the at least one traveling drive unit based on the conditions of the handles that are detected based on detection signals from the respective handle condition detection units;
a pair of right and left shafts fixed to the respective handles and extending in the frame front-rear direction; and
a pair of right and left tubes that are attached to the frame so as to extend in the frame front-rear direction, the tubes being configured to house the respective shafts such that the shafts are movable in the frame front-rear direction.

2. The walking assist device according to claim 1, wherein the tubes and the shafts include retaining structures that prevent detachment of the shafts from the tubes.

3. The walking assist device according to claim 1, wherein the tubes and the shafts include rotation prevention structures that prevent rotation of the shafts in the tubes about shaft central axes extending in the frame front-rear direction.

4. The walking assist device according to claim 1, wherein:
a reference shaft position is set for each of the shafts, the reference shaft position being a reference position in the frame front-rear direction relative to the tube that houses the shaft; and
each of the tubes is provided with a shaft position recovery portion configured to return, to the reference shaft position, the shaft and the handle moved forward or rearward from the reference shaft position.

5. The walking assist device according to claim 4, wherein each of the tubes is provided with a locking mechanism switchable between a locked state in which the shaft is held within a fore-and-aft limit range in the frame front-rear direction such that the shaft is located in vicinity of the reference shaft position and an unlocked state in which the shaft is permitted to move in the frame front-rear direction beyond the fore-and-aft limit range in the frame front-rear direction.

6. The walking assist device according to claim 1, further comprising
a traveling velocity detection unit configured to detect a traveling velocity of the walking assist device relative to a ground, wherein:
the handle condition detection units are configured to output, to the electronic control unit, detection signals depending on positions of the shafts and the handles in the frame front-rear direction relative to the tubes, respectively; and
the electronic control unit is configured to
calculate fore-and-aft handle positions that are positions of the handles in the frame front-rear direction relative to the frame, based on the detection signals from the respective handle condition detection units,
calculate handle moving velocities that are moving velocities of the handles relative to the walking assist device, based on the calculated fore-and-aft handle positions, and
control the at least one traveling drive unit so as to achieve a target velocity based on the traveling velocity and at least one of i) the fore-and-aft handle positions and ii) the handle moving velocities.

7. The walking assist device according to claim 6, wherein:
the at least one driving wheel includes a right driving wheel and a left driving wheel:
the at least one traveling drive unit includes a right traveling drive unit configured to drive the right driving wheel and a left traveling drive unit configured to drive the left driving wheel; and
the electronic control unit is configured to control each of the right traveling drive unit and the left traveling drive unit so as to achieve the target velocity for a corresponding one of a right side and a left side based on the traveling velocity and at least one of i) the fore-and-aft handle position and ii) the handle moving velocity of a corresponding one of the handles.

8. The walking assist device according to claim 5, further comprising
a traveling velocity detection unit configured to detect a traveling velocity of the walking assist device relative to a ground, wherein:
in the locked state, the shafts are movable in the frame front-rear direction within the fore-and-aft limit range;
the handle condition detection units are configured to output, to the electronic control unit, detection signals depending on positions of the shafts and the handles in the frame front-rear direction relative to the tubes, respectively; and
the electronic control unit is configured to
calculate fore-and-aft handle positions that are positions of the handles in the frame front-rear direction relative to the frame, based on the detection signals from the respective handle condition detection units, and
control the at least one traveling drive unit such that the walking assist device is accelerated in a direction of the traveling velocity when the fore-and-aft handle positions are in front of positions corresponding to the reference shaft position in the locked state.

9. The walking assist device according to claim 8, wherein the electronic control unit is configured to
calculate handle moving velocities that are moving velocities of the handles relative to the walking assist device, based on the calculated fore-and-aft handle positions, and
control, in the unlocked state, the at least one traveling drive unit so as to achieve a target velocity based on the traveling velocity and at least one of i) the fore-and-aft handle positions and ii) the handle moving velocities.

10. The walking assist device according to claim 9, wherein:
the at least one driving wheel includes a right driving wheel and a left driving wheel:
the at least one traveling drive unit includes a right traveling drive unit configured to drive the right driving wheel and a left traveling drive unit configured to drive the left driving wheel; and
the electronic control unit is configured to control each of the right traveling drive unit and the left traveling drive unit so as to achieve the target velocity for a corresponding one of a right side and a left side based on the traveling velocity and at least one of i) the fore-and-aft handle position and ii) the handle moving velocity of a corresponding one of the handles.
